(19) United States
(12) Patent Application Publication
(10) Pub. No.: US 2003/0038707 A1
(43) Pub. Date: Feb. 27, 2003

(54) Method for secured identification of user's id

(76) Inventor: Avner Geller, Tel Aviv (IL)

Correspondence Address: FISH & RICHARDSON PC, 225 FRANKLIN ST, BOSTON, MA, 02110, US

(21) Appl. No.: 10/221,930

(22) PCT Filed: Mar. 18, 2001
(86) PCT No.: PCT/IL01/00258

(30) Foreign Application Priority Data
Mar. 17, 2000 (IL) 135150

(51) Int. Cl. G06F 7/04

(52) U.S. Cl. 340/5.8

(57) ABSTRACT

The invention provides a method and a system of establishing safe and secured identification and authentication of a user, especially a credit or a smart card user, without requiring the users to directly feed their credit card number or names into the computer system. A direct line or a communication network is communicating between a user and an identification center, in some of the preferred embodiments of the present invention through an intermediate service provider, (for example the identification center is a credit card company, or a central access verification and control unit and the intermediate service provider is an e-commerce Internet services or products provider). The method of establishing secured identification and authentication procedure of a user by an identification center is based on the user and the identification center sharing a common secret. The common secret information lies is a string of identification data that includes N symbols associated with respective N ordinal numbers. Based on this data a center string key is created, common to the identification center and the user, that includes I≦N symbols and I≦N of the associated ordinal numbers.

### FIELD OF THE INVENTION

The invention relates to a way of conducting secured computer-based electronic identification and authentication for safe communication and transactions through open readily accessible and standardized computer communication networks, such as the Internet, or alternatively through a closed communication network such as Intranet, or access control systems.

### BACKGROUND OF THE INVENTION

It is a common requirement to verify the authenticity of data, which may represent monetary value or may imply the authenticity of the entity generating that data. A typical application where authentication is critical to avoid forgery is found in credit transactions using credit cards or smart cards. For example, before a credit transaction is undertaken the authenticity of the card and/or transaction value dispensed therefrom must be proved to the authentication system (such as the computer at the credit card center, or the vendor server hosting an e-commerce Internet site.), involved in the transaction.

Prior art systems for preventing fraudulent use of such systems have included the use of secret identification numbers, known only to authorized system users. These numbers are generally stored on a computer memory associated with a central data processing and communication unit resident at the credit card company computer center, the Internet Service Provider, or the e-commerce vendor server facilities. When an authorized user desires to obtain access to the system, for example to enter into an e-commerce transaction, he must identify himself at the transaction execution terminal, such as a PC connected to the Internet network using IP based communication, by keying his secret identification number or alphanumeric ID string into the terminal. The central data processing unit compares the number keyed by the customer with the stored secret number or ID string corresponding to the customer's account, and if the numbers match, the transaction is authorized.

To impede forgery the user (for example, the credit card owner) should possess the means to produce authentication elements based partially or fully on the secret number or alphanumeric ID string. This implies that the user must possess some secret. The difficulty in proving authenticity is in providing the means to the authenticator to achieve that proof.

One alternative technique that some systems employ is based on an algorithm driven by a secret key such that a data string processed by the algorithm, results in a secret transformation of that data. The data so transformed is used as an authentication certificate or code, which may be tested by an authenticator. One method of testing involves the authenticator in performing the same secret transformation of the data to yield an authentication certificate, which is compared for equality with that provided by the user (for example, a credit card holder or a smart card).

The underlying concept of this technique is that the authenticator must duplicate the data manipulation by the user so as to compare the result for equality. An element in this technique is that the authenticator must also have knowledge of the key. If several authenticators need to authenticate an entity, each must possess the secret key. The secret key must be securely distributed to each potential authenticator prior to the event. This secured communication solution approach should have the ability to limit authentication capabilities to only those trusted authenticators, which may utilize this function.

Another known alternative technique employs the art of private and public key cryptography wherein an asymmetrical algorithm is used. Public key cryptography is described in the article: Communications of the ACM, vol. 21, No. 2, February 1978, pages 120-126, R. L. Rivest et al. “A Method for Obtaining Digital Signatures and Public Key Crypto-systems”. In this technique, a data element or a change sensitive compression of a data string is enciphered using a secret key or procedure. Authenticity is proven by obtaining the original data element (or change sensitive compression), which is used as a reference value and then using a public key or procedure to decipher the data supplied by the source entity.

Equality of the deciphered data with the reference data implies that the secret key or procedure was employed and thus that the data is authenticated.

The use of the concept of a private secret key and a public key for secured communication is described also in U.S. Pat. No. 4,405,829 Rivest, et al. Sep. 20, 1983 “Cryptographic communications system and method”.

The system includes a communications channel coupled to at least one terminal having an encoding device and to at least one terminal having a decoding device. A message-to-be-transferred is enciphered to ciphertext at the encoding terminal by first encoding the message as a number M in a predetermined set, and then raising that number to a first predetermined power (associated with the intended receiver) and finally computing the remainder, or residue, C, when the exponentiated number is divided by the product of two predetermined prime numbers (associated with the intended receiver). The residue C is the ciphertext. The ciphertext is deciphered to the original message at the decoding terminal in a similar manner by raising the ciphertext to a second predetermined power (associated with the intended receiver), and then computing the residue, M′, when the exponentiated ciphertext is divided by the product of the two predetermined prime numbers associated with the intended receiver. The residue M′ corresponds to the original encoded message M.

This technique permits any authenticator to know the public key or procedure with which to prove the authenticity of data originating from an entity possessing the complementary secret key or procedure.

However, the publicly known procedure must not permit the secret key or procedure to be easily determined. Generally, the algorithms possessing this property require substantial computing power to perform the secret procedure. This usually renders them unsuitable for users having low cost data entry terminals.

It is apparent that most present art credit card number based existing transaction arrangements whether cash based, credit card based, or grounded on some derivative transaction arrangement, as exemplified above, fail to provide security confidence for transactions by the purchasing parties in the transaction.

A most common problem limiting the public use of electronic based commercial transactions is related to the strong public reluctance from the implementation and direct feeding to the communication network and through it to the computerizes authentication system of the credit card ID and security numbers. The limited use of electronic transactions by the average related electronic banking services, credit card, or e-commerce service users, lies in the fact that they do not rely on the security and safety of the currently available transaction security support systems.

A potential related security problem arise the insecurity feeling of the common user, following the ordinary credit card ID number feeding into the computer system and the use of secret code numbers. The problem arises out of the common fear of users from possible wire-tapping on the communications link associated with a user remote terminal, which can enable the determination of secret identification numbers, corresponding to the customer account numbers.

There is accordingly a need in the art to have a simple yet safe and secured method for verifying the identity of an authorized user from a very large database of systems users. The method should further support the execution of user's identification via communication channels in general and the Internet network in particular. The method is required to support secured access to any kind of data communication networks. Enabling a reliable user's identification and authentication process, the method could support the identification of the user prior to granting access permission, in applications related to enabling entrance to a secured area through an access control systems. The method could also serve the needs for computer systems secured accessibility in general and for financial and commercial transactions in particular.

Related to the above there is a need in the art for a secured and safe electronic transaction or payment system, which is easy to be understood and to be implemented by a non-educated user and is economical to use for any transaction. In particular, there is also a need in the art to provide a simple to operate, yet relatively safe secured method for the use of credit and smart cards in electronic banking and in e-commerce electronic transactions, without directly feeding into the user terminal neither the full credit card ID number and the related secret number, nor the full card holder name.

### SUMMARY OF THE INVENTION

According to the present invention there is provided a method of establishing safe and secured identification and authentication of a user, especially a credit or a smart card user, without requiring the users to directly feed their full credit card number or full names into the computer system, thus keeping the system safer and more user friendly.

A direct line or a communication network is communicating between a user and an identification center, in some of the preferred embodiments of the present invention through an intermediate service provider, (for example the identification center is a credit card company, or a central access verification and control unit and the intermediate service provider is an e-commerce Internet services or products provider).

The method of establishing secured identification and authentication procedure of a user by an identification center is including the steps of; (a) providing a string of identification data that includes N symbols associated with respective N ordinal numbers; (b) providing a center string key, common to the identification center and the user, that includes I≦N of the ordinal numbers. The center string key is divided into at least two groups, each including a respective j(I)≧2 ordinal numbers;(c) reordering the ordinal numbers in the center string key and constructing an ordered data inquiry string that includes at least two inquiry groups;(d) the user constructing an ordered user ID data reply string that includes at least two reply groups that correspond to the at least two inquiry groups, by performing; (i) for each group I, selecting k≦j(I) symbols that corresponds to k ordinal numbers in the inquiry group and placing them or a function thereof in the respective user reply group; the user reply group does not include indication as to correspondence between the k symbols and the k ordinal numbers; (e) the user sending to the identification center at least the ordered user ID data reply string; (f) the identification center receiving the ordered user ID data reply string, and for each reply group extracting the data symbols and comparing them to data symbols in a corresponding simulated reply group, the corresponding simulated reply group is generated by simulating ordered user ID data reply group processed from the data inquiry string; and (g) the identification center providing an indication to the user if a score indicating a matching degree derived by the comparison step between the ordered user ID data reply string and simulated ordered user ID data reply string, is sufficient or not.

According to further features in a preferred embodiment of the invention described below there is provided a method for establishing a safe and secured identification and authentication procedure through an active intermediate service provider, further comprising an intermediate service provider coupled to the user and an identification center; and wherein the step (e) further includes: the user sending to the intermediate service provider at least the ordered user ID data reply string; the intermediate service provider sending to the identification center at least the ordered user ID data reply string and an inquiry identification string; the inquiry identification string being unique per each transaction that the user executes utilizing the intermediate service provider and the identification center; and wherein the step (f) further includes: the identification center further receiving the inquiry identification string; and wherein the step (g) further includes: the identification center providing an indication to the intermediate service provider if a matching criterion implementation result, obtained in the comparison step, is sufficient or not; in the case that the result is sufficient, the identification center providing a confirmation to the intermediate service provider to execute a transaction on behalf of the user by returning to the intermediate service provider the inquiry identification string; and (h) the intermediate service provider providing to the user a confirmation regarding the provision of the execution of transaction by transferring to the user the inquiry identification string, signifying that the indication stipulated in step (g) is sufficient.

The present invention discloses an innovative yet simple and practical ID data encoding method and a system for combining enhanced security together with improved confidence of use of communication networks for conducting financial and commercial transactions through a dedicated communication channel or through a private or a public network, or to establish an access control procedure to protected areas, or to secured communication channels and networks. The present invention method and system successfully addresses the shortcomings of the presently known users identification methods, by providing an identification process and a related system based on a secured, yet user friendly identification concept, under which the user is not feeding into the terminal his personal ID data, an act which in many cases creates for the user a feeling of low confidence and reluctance from continuing in the identification process. Instead, the user is feeding to his terminal and transferring to the identification center only a user self encoded ID data string, of a reduced number of data symbols. The pre-encoded ID data string may be combined of a list of any user selectable identification numbers or other symbols, preferably but not necessarily selected from the group consisting of the user's credit card number, the credit card secret number, birth date and the user's other formal identity numbers (passport number, driving license, etc,). In any case, explicitly the present invention method avoids the entry to the user terminal of the entire user credit or a smart card number, or their secret related codes (PIN numbers).

Although the scope of the present invention is to provide secured and simple identification method to users of various types of communication systems, in another embodiment of the present invention an additional level of security may be provided. This additional step is also supporting the identification center required memory access step to allocate the specific user center string key. According to this preferred embodiment a provisional stage of the user's identification is added by which an initial step of exchange and approval of a secret number between the user and the identification center is executed, followed by the retrieval by the identification center of the user's dedicated center string key, prior to the start of the identification process according to method described below. Preferably instead of this provisional stage the identification center is creating an intermediate identification score for all locally stored center string keys, and selects the center string key enabling the highest matching score to the user reply string, to identify the most likable user, prior to proceeding to the following steps at the end of which an indication is provided to the user if the score obtained by implementing a matching criterion on the most likable user related center string key, derived by the related center string key comparison step, is sufficient or not.

According to further features in a preferred embodiment of the invention described below comprising the method, further including the steps of; (b) (i) the user sending a commonly shared secret key to the identification center and gets a provisional identification certificate; and (i) the identification center comparing the commonly shared secret key to a pre-stored secret key and in the case of match, retrieving the center string key, prior to proceeding to step (c).

According to still further features in a preferred embodiment of the invention described below the method is further including the step of:(f)(i) for every center string key, the identification center executing user's steps and repeating steps; (c);(d);(e);(f), creating a series of simulated ordered user ID data reply strings, each in respect of a different center string key; each simulated ordered user ID data reply string is associated with a score indicating the matching degree between the ordered user ID data reply string and the respective simulated ordered user ID data reply string; and selecting the simulated ordered user ID data reply string having the highest score to identify a corresponding center string key and therefrom the most likable user, prior to proceeding to step (g).

According to still further features in a preferred embodiment of the invention described below the method further including the step of: (b) (i) the user sending a commonly shared secret key to the identification center through the intermediate service provider and gets back from the intermediate service provider a provisional identification certificate; and (ii) the identification center comparing the commonly shared secret key to a pre-stored secret key and in the case of match, retrieving the center string key prior to proceeding to step (c).

According to still further features in a preferred embodiment of the invention described below the method further including the step of: (i) in any following identification procedure associated with the intermediate service provider, the user sending only to the intermediate service provider the user provisional identification certificate, prior to proceeding to step (c).

According to still further features in a preferred embodiment of the invention described below the method, further including the intermediate user entry acceptance and a provisional identification step of:(b)(ii) the user, the intermediate service provider and the identification center are repeating steps (c);(d);(e);(f);(g) of the identification procedure for n times, each time creating a new ordered data inquiry string; (iii) for each of the n identification procedures the identification center, creating an intermediate identification score for all stored users center string keys, implementing the matching criterion, selecting the reply string having the highest matching score to identify the most likable user; (iv) at the end of n identification procedures the identification center deciding based on the score of the most likable user, if the score is sufficient, creating in such a case a provisional user identification certificate in a form of a string of symbols; and (v) the identification center sending the user provisional identification certificate to the intermediate service provider, prior to proceeding to step (h).

According to still further features in a preferred embodiment of the invention described below the method of claim 1, further comprising the steps of:(h) the user getting from the identification center a permission for activating an operation selected from the group comprising of executing a transaction, and an entry permission to a restricted area:(i) at the end of the selected operation the identification center and the user are executing a second user identification procedure, repeating the steps of; (c) to (g); and (j) the identification center providing a final certificate, selected from a group consisting of a final transaction approval and of an exit permission command from the restricted area, as the result of a sufficient score indicating a matching degree obtained at the end of said second user identification procedure.

According to still further features in a preferred embodiment of the invention described below the method of claim 1, further comprising the step of:(h) in response to receipt of insufficient indication as stipulated in step (g), repeating the steps (c) to (g) a number M≧1 cycles and in response to receipt of insufficient indication, as stipulated in step (g), in each one of the M times, the identification center activates an action selected from the group that includes: (1)stopping the identification process and declaring failure, and (2) constructing a new ordered data inquiry string that includes a different set of selected ordinal numbers as stipulated in the step (c); and executing the steps (c) to (g).

According to still further features in a preferred embodiment of the invention described below, the method further including the steps applied in at least one of the cycles: (i) providing a new center string key as stipulated in the step (b) and executing the steps (c) to (g); and (ii) applying the steps (d) to (g) and in response to receipt of insufficient indication as stipulated in the step (g), repeating the step (i) L≧1 times, or until sufficient indication is obtained.

According to still further features in a preferred embodiment of the invention described below, the method wherein reordering of the ordinal numbers in the center string key involves permutations of symbols between at least two from among the center string key groups.

According to still further features in a preferred embodiment of the invention described below, the method wherein the matching criterion obtained in the comparison step is based on a rule that a predefined percent P of user ordered ID data reply string symbols in each reply group being identical to corresponding symbols in the simulated reply group.

According to still further features in a preferred embodiment of the invention described below, the method wherein the predefined P equals 100 percent.

According to still further features in a preferred embodiment of the invention described below the method wherein the function is a selection of k symbols out of j symbols in each one of the reply groups.

According to still further features in a preferred embodiment of the invention described below, the method further providing a set of functions, and wherein the function, stipulated in step (d)(i), is a different function in the set for each respective user reply group.

According to still further features in a preferred embodiment of the invention described below the method wherein the symbols are all digits.

According to still further features in a preferred embodiment of the invention described below the method further comprising the step of: applying checksum to the symbols of each reply group, to create a checksum error code and adding the code or a portion thereof to the tail of each the reply group in the ordered user ID data reply string.

According to still further features in a preferred embodiment of the invention described below the method further comprising the step of: applying checksum to the symbols of the ordered user ID data reply string, to create a checksum error code and adding the code or a portion thereof to the tail of the ordered user ID data reply string.

According to still further features in a preferred embodiment of the invention described below, the method wherein the function creates a number as the results of its operation on the k≦j symbols, in each one of the reply groups.

According to still further features in a preferred embodiment of the invention described below, the method wherein the function further selecting at least one digit of a selectable significance place in the number.

According to still further features in a preferred embodiment of the invention described below the method wherein the center string key of symbols is structured of any order of the user personal identification numbers, selected from the group comprising of at least the user's credit card number, the user's credit card secret number, the user's birth date and the user's personal identity numbers.

According to still further features in a preferred embodiment of the invention described below, the method further comprising the steps of; 30 (e), (ii) encoding the symbols in the respective user ID data reply string by implementing the following steps; (1) using a personal multi-digit ID number of the user, including any combination and any repetitive number of the digits varying from 0 to 9, for generating a new serial group of N digits, said new serial group including said original ID number digits in their original order of appearance, adding to said group when ordered in a linear sequence, any missing digit from 0 to 9 that does not appear in said user original ID number group of digits; (2) assigning and fitting a set of running serial numbers, each of said running numbers assigned is fitted to each said digit in said new serial group of N digits and repeating this step of fitting and assigning a set of running serial numbers to said new serial group of digits, each time with a new set of consecutive running serial numbers, for at least N times; (3) replacing each symbol, in case it is a digit, in said respective user ID data reply string by said assigned serial number fitted to said digit and by the following set assigned serial number fitted to the same said digit; (4) if a digit appears 1<M<N times in said new serial group of digits then said digit in its Mth. Appearance in the user ID data reply string will be replaced by the assigned serial number in the M consecutive step, of the steps of fitting and assigning a set of running serial numbers to said digits; and (5) in case said symbol is a digit, replacing each said symbol in said respective user ID data reply string by the result of a mathematical function operated on the assigned serial number fitted to said digit and on the following set serial number fitted to the same said digit.

According to still further features in a preferred embodiment of the invention described below, the method further comprising the steps of; 31;(e);(ii);(5) executing a function between said assigned serial number fitted to said digit and a second number from the following set of assigned serial numbers fitted to same said digit; and (6) replacing said assigned serial number fitted to said digit in said respective user ID data reply string by first or last digit of the result of said function execution.

According to still further features in a preferred-embodiment of the invention described below, the method function is selected from the group including at least the functions of multiplication, division, sum, subtraction and the function wherein the number derived by first said assigned serial number is raised in the power of the following assigned serial number fitted to same said digit.

According to still further features in a preferred embodiment of the invention described below, in the method wherein an intermediate service provider is coupled to the user and to the identification center; the method further comprising the step of: (e); (i) the user is further sending directly to the identification center at least a second ordered user ID data reply string; and wherein said step (g) further includes: (g);(i) the identification center further receiving from the user said second ordered user ID data reply string and executing on it steps (l); (g) and (h); and wherein said step (h) further includes step: (h); (i) the identification center providing an indication to both to the intermediate service provider and to the user if both matching criterion implementation results, obtained in both said comparison steps (g), (i), and (l), (h), are sufficient or not; in the case that both said results are sufficient, the identification center providing a confirmation to the intermediate service provider to execute a transaction on behalf of the user by returning to the intermediate service provider an inquiry identification string; and (i) the intermediate service provider providing to the user a confirmation regarding said provision of said execution of transaction by transferring to the user the inquiry identification string, signifying that the indication stipulated in said step (h) is sufficient. According to another embodiment of the present invention, there is provided a system for establishing safe and secured identification of a user. A direct line or a communication network, is communicating between a user, an optional intermediate service provider and an identification center. The system is establishing safe and secured identification and authentication of a user by an identification center, comprising the steps of; (a) providing a string of identification data that includes N symbols associated with respective N ordinal numbers; (b) providing a center string key, common to the identification center and the user, that includes I≦N of the ordinal numbers divided into at least two groups, each including a respective j≧2 ordinal numbers;(c) reordering the ordinal numbers in the center string key and constructing an ordered data inquiry string that includes at least two inquiry groups;(d) the user constructing an ordered user ID data reply string that includes at least two reply groups that correspond to the at least two inquiry groups, by performing; (i) for each group, selecting k≦j symbols that corresponds to k ordinal numbers in the inquiry group and placing them or a function thereof in the respective user reply group; the user reply group does not include indication as to correspondence between the k symbols and the k ordinal numbers; (e) the user sending to the identification center at least the ordered user ID data reply string; (f) the identification center receiving the ordered user ID data reply string, and for each reply group extracting the data symbols and comparing them to data symbols in a corresponding simulated reply group, the corresponding simulated reply group is generated by simulating ordered user ID data reply group processed from the data inquiry string; and (g) the identification center providing an indication to the user if a score indicating a matching degree derived by the comparison step between the ordered user ID data reply string and simulated ordered user ID data reply string, is sufficient or not.

According to a preferred embodiment of the invention described below there is provided a system for establishing secured identification and authentication procedure of a user by an identification center including the steps of; (a) providing a string of identification data that includes N symbols associated with respective N ordinal numbers; (b) providing a center string key, common to the identification center and the user, that includes I≦N of the ordinal numbers divided into at least two groups, each including a respective j(I)≧2 ordinal numbers;(c) reordering the ordinal numbers in the center string key and constructing an ordered data inquiry string that includes at least two inquiry groups;(d) the user constructing an ordered user ID data reply string that includes at least two reply groups that correspond to the at least two inquiry groups, by performing; (i) for each group, selecting k≦j symbols that corresponds to k ordinal numbers in the inquiry group and placing them or a function thereof in the respective user reply group; the user reply group does not include indication as to correspondence between the k symbols and the k ordinal numbers; (e) the user sending to the identification center at least the ordered user ID data reply string; (f) the identification center receiving the ordered user ID data reply string, and for each reply group extracting the data symbols and comparing them to data symbols in a corresponding simulated reply group, the corresponding simulated reply group is generated by simulating ordered user ID data reply group processed from the data inquiry string; and (g) the identification center providing an indication to the user if a score indicating a matching degree derived by the comparison step between the ordered user ID data reply string and simulated ordered user ID data reply string, is sufficient or not.

According to further features in a preferred embodiment of the invention described below there is provided a system for establishing a safe and secured identification and authentication procedure through an active intermediate service provider, further including an intermediate service provider coupled to the user and an identification center; and wherein the step (e) further includes: the user sending to the intermediate service provider at least the ordered user ID data reply string; the intermediate service provider sending to the identification center at least the ordered user ID data reply string and an inquiry identification string; the inquiry identification string being unique per each transaction that the user executes utilizing the intermediate service provider and the identification center; and wherein the step (f) further includes: the identification center further receiving the inquiry identification string; and wherein the step (g) further includes: the identification center providing an indication to the intermediate service provider if a matching criterion implementation result, obtained in the comparison step, is sufficient or not; in the case that the result is sufficient, the identification center providing a confirmation to the intermediate service provider to execute a transaction on behalf of the user by returning to the intermediate service provider the inquiry identification string; and (h) the intermediate service provider providing to the user a confirmation regarding the provision of the execution of transaction by transferring to the user the inquiry identification string, signifying that the indication stipulated in step (g) is sufficient.

### BRIEF DESCRIPTION OF THE DRAWINGS

The invention is herein described, by way of example only, with reference to the accompanying drawings, wherein:

FIG. 1 shows in a block diagram form, an identification system structured from a communication channel coupled to a user, an optional intermediate service provider and an identification center, according to the present invention.

FIG. 2 is a schematic table containing by a way of an example, a center string key to be used by the user and by the identification center, required for the subsequent encrypted data identification procedure.

FIG. 3 is a schematic table in accordance with the same embodiment of the present invention, containing in the first row an ordered data inquiry string and in the second row blank spaces for the user to insert the symbols constructing the ordered user ID data reply string.

FIG. 4 is a table in accordance with the same embodiment of the present invention, containing an example of the user's terminal stored center string key, the received ordered data inquiry string and the ordered user ID data reply string, as sent back by the user to the identification center.

FIG. 5 shows a flow diagram of the preliminary stage related to the creation of a center string key; a standard identification data string composed of selected groups of symbols from the user's ID database, common to the user and to the identification center.

FIG. 6 shows a flow diagram of the present invention identification process stage, related to the creation of a ordered data inquiry string

FIG. 7 shows an overall flow diagram of the present invention identification and authentication process of a user's ID, with tasks shared between the user and the identification center.

FIG. 8 shows an overall flow diagram of another embodiment of the entire process of a user's ID identification and authentication, with tasks shared between the user, the intermediate service provider and the identification center.

FIG. 9 is a table in accordance with some embodiments of the present invention, containing an example of a user ID number and the use of this number to further encode the string of symbols composing the ordered user ID data reply string, as prepared by the user and further sent by the user back to the identification center.

### DESCRIPTION OF THE PREFERRED EMBODIMENTS

The present invention provides a method and a system for secured identification and authentication of user's I.D. data by an identification center. The method and the system are based on the principle that the user is creating an ordered user ID data reply string by executing a set of guided transformations on a string of ID data symbols, preferably but not necessarily, alpha-numeric symbols. The string is constructed by the user using a combination of a part or the whole of a center string key, which is a data string common to the user and the center, containing user's selected string of alphanumeric and other symbols, reflecting the user's personal ID data. The transformation process is dictated by a computer generated set of instructions dictated by the identification center for restructuring a part or the hole of the center string key. The instructions for restructuring are changed for every inquiry and are sent to the user in one embodiment of the present invention in the form of an ordered data inquiry string, created by and sent to the user from the identification center. In another preferred embodiment of the present invention the ordered data inquiry string is created by the user himself.

After the creation of the ordered user ID data reply string by the user, the ordered user ID data reply string is sent to the identification center where it is compared for level of matching to a simulated ordered user ID data reply string created by and at the identification center. The center is using exactly the same combination of a part or the whole of the center string key having the same symbols and structure as the one created by the user. On that string the identification is repeating the same transformations that has been done by the user. The results of these two strings comparison process reflect the capabilities of the user to demonstrate the fact that he shares with the identification center the same common secret center string key. In practice the identification center is evaluating if the comparison results score, indicating a matching degree derived by the comparison step between the ordered user ID data reply string and the simulated ordered user ID data reply string, is sufficient or not. If sufficient, then the identification center is issuing to the user, through the communication network, an authentication approval certificate.

Specifically, the present invention can be used to create a simple, yet relatively safe and secured method for verifying the identity of an authorized person, making use of the user's selected string of personal ID data, in order to enable the execution of data communication through a network in general, such as the permission and execution of financial or commercial transactions, through the Internet infrastructure.

The present invention method enables the identification of the user and the authentication of his personal ID data for the safe and secured execution of transactions having a value and in particular in transactions having a commercial value. The present invention avoids the user from the need to directly feed to the communication network and through it to the communication center, at any stage during this process, the whole number of his credit card or smart card, an act that is creating high reluctance of use by many users.

The principles and operation of the user's identification and authentication method and system according to the present invention, may be better understood with reference to the drawings and the accompanying description.

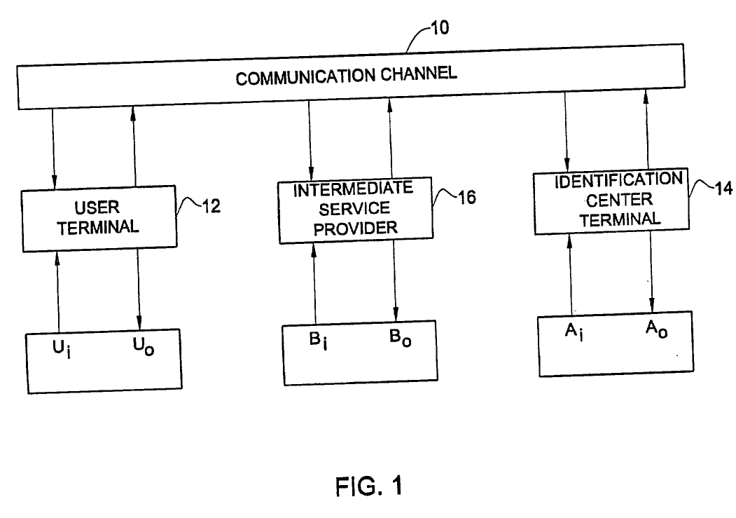

Referring now to the drawings, FIG. 1 illustrates in a schematic block diagram form, an identification system 1 structured from a communication channel coupled to a user, an optional intermediate service provider and an identification center.

The user, the intermediate service provider and the identification center entities, communicate with each other through a communication system, e.g. the Internet, in accordance with the present invention.

This system 1 includes a data communication channel 10, standing for a non limiting example of a communication network, an intermediate service provider terminal 16, a user terminal 12 and an identification center terminal 14; all terminals are coupled to the channel 10. The user terminal 12 which can be any kind of a computer, or a data terminal, or a computerized communication device, connected to a network, has an associated user data input of identification data in the format of an ordered user ID data reply string Ui and an associated user terminal data output to the user, in the form of an ordered data inquiry string Uo, received through the communication channel 10 from the identification center terminal 14. In another preferred embodiment of the present invention the ordered data inquiry string Uo is also fed by the user. The identification center terminal 14, typically although not necessarily, a bank or a credit card central computer center, or a central access control system for secured area or secured communication networks, has an associated input Ai, which is a center string key comprised of a string of symbols, only once fed and stored at the identification center and at the user terminal memories. The center key string is farther used in all consequent identification processes, serving as a common key string of data symbols, common to the user and to the identification center. In accordance with central embodiments of the present invention, there is provided an intermediate service provider terminal 16 which is for example, a computerized service provider, or an e-commerce vendor, and has an associated data input from two sources. The first source of data is the user, the user transfers an the ordered data reply string which is unique for every inquiry and is created as the response to the associated ordered data inquiry string. The other is a string of data symbols, given only once by the user, according to one possible embodiment of the present invention, and concerning the user first entry identification information like name, address, telephone number, required to get a client ID string of symbols that will serve him for further prompt entries to the system. In another possible embodiment of the present invention the other string fed by the user to the intermediate service provider, for further transfer by the intermediate service provider to the identification center, is serving for the preliminary entry stage of the user to the identification and authentication system when the user is using an entry PIN number, defined as the commonly shared secret key. This stage is required in order to enable the identification center to retrieve the user associated center string key from the memory, prior to the start of the identification process. The other data input to the intermediate service provider 16 is coming through the communication network 12 from the identification center, in the case of a positive identification, when the user meets the matching criterion minimum score level. An associated output of a confirmation and a transaction certificate for the user, is sent in this case from the intermediate service provider to the user terminal 12, namely a user provisional identification certificate, processed and sent from the intermediate service provider terminal 16, through the communication channel 10, to the user terminal 12. The present invention is not bounded by any specific structure of the terminals and/or the type of the communication channel.

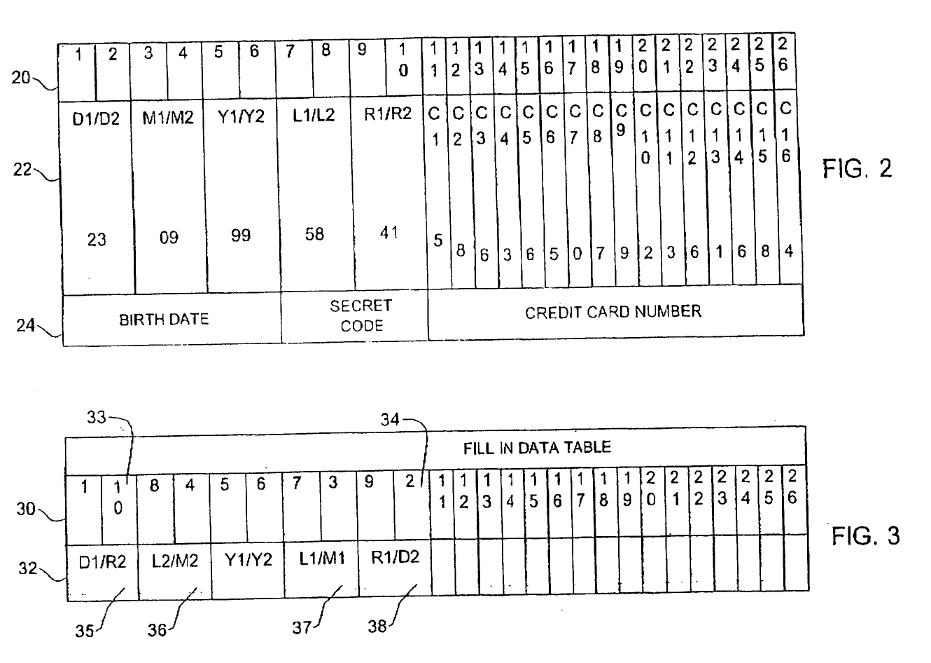

FIG. 2. illustrates schematically in a table form a table 2 containing an exemplary center string key, consisting of a string of alphanumeric symbols representing the user ID data. Any kind of combination of symbols can be selected and can be used for the generation of the common key string. The center string key is stored and used in a preliminary identification procedure cycle, by both the user and the identification center, as the raw common data string, required for the secured identification procedure. Line 20 in table 2 includes the ordinal numbers associated with each of the symbols in the ID data in the center string key. Line 22 in table 2 includes a descriptive abbreviation (e.g. D1/D2—the two digits composing the number of the user's day of birth) of the string of ID data symbols/digits in the center string key, each one of these symbols has its associated ordinal number, for example; D1 is associated with ordinal number 1. The ID data digits, e.g. 23 standing for the day field of the date of birth in line 22, are divided into groups, in this embodiment each of the date and secret number constructing groups is structured from two digits and the credit card group is constructed of 16 digits. Line 22 in table 2 includes the numerical values of the specific ID data of the user in this example. Line 24 in table 2 includes the textual description for each of the six groups in this example of a center string key. In this example a single name—birth date, is representing a common title for the first three groups (e.g. birth date consists of three groups, each structured from two digits; day, month and year of birth). The other three groups in this center key string example are the secret code number of the user card (represented by two groups) and an additional single group, structured from the full number of the user's credit card, consisting of 16 symbols (digits).

FIG. 3 illustrates in a table form a schematic table 3 containing in the upper line 30 an example of an ordered data inquiry string. The ordering procedure in this preferred example is done by permuting (exchanging positions) of the ordinal numbers, e.g. digits, of a selected number of four (1^{st}.,2^{nd}.,4^{th}.,5^{th}.) of the six data groups included in the center string key of this example. For example in the example of the embodiment detailed in FIG. 3, ordinal number 2 from the first center key string group is permuted with ordinal number 10 from the fifth group of this string, spaces 34 and 33 respectively. To clarify the practical aspect of this reordering step, the ordinal number related to the second digit of the birth date (D2) is permuted with the ordinal number related to the last digit of the user four digits secret code (PIN) number (R2), table 3 spaces 34 and 33 respectively. The second line 32 contains blank spaces, the user should insert to the blank spaces the corresponding symbols required to construct the ordered user ID data reply string, deriving the required construction steps from the ordinal numbers relation to symbols according to their appearance in the original center string key, as stored in the user's terminal memory. Each ID data digit related blank space is associated in table 3 line 32, with its descriptive ID meaning abbreviation (e.g. D1/R2). In this preferred embodiment the permuted ID data digits are from only 3 groups; the day, the month and the secret code groups of digits 35,36,38 are permuted, each group is constructed of two digits. By this specific example the credit card group 16 digits of this example are not utilized for the preferred ordering procedure (in this example permuting the related symbols). Thus, in order not to reveal the related sixth group center key string data contents, the sixth group (credit card number) symbols are not filled into the blank spaces and therefore are not a part of the user sent ordered user ID data reply string 32 of this example.

It is clear that the above detailed description, regarding the structuring of the ordered data inquiry string and the corresponding ordered user ID data reply string, is given only by way of an example and accordingly any other selection of some or all of the groups from the total number of groups structuring the center string key in this example, are equally applicable according to the invention. The same holds to the use of different ordinal numbers for permutations in the groups selected for the ordering purposes.

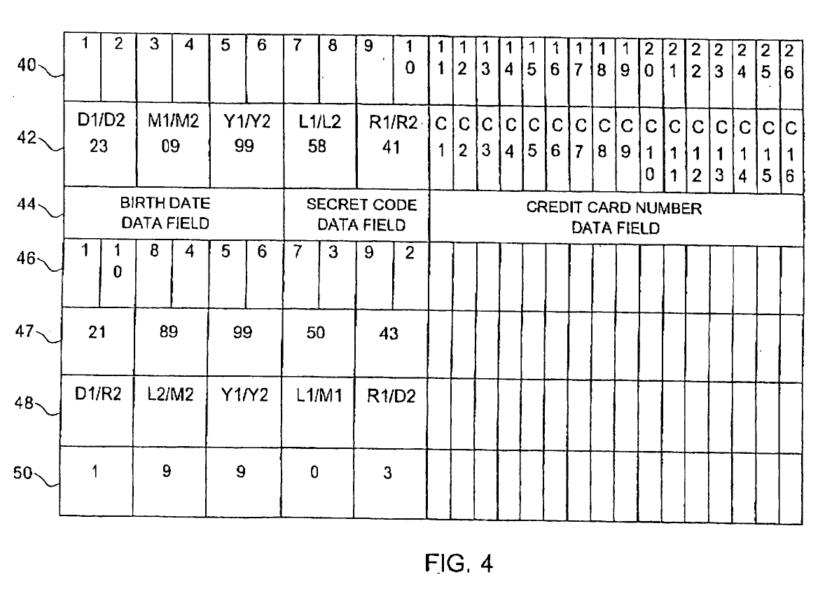

FIG. 4 illustrates in a table form, a table 4 containing an example of the user's stored center string key structure, the identification center ordered data inquiry string and the ordered user ID data reply string, as prepared and sent back by the user to the identification center. The user's data processing steps demonstrated in this example, are based on the encoding information derived from the ordered string of ordinal numbers, described in FIG. 3 lines 40,42 and 46. Line 40 in table 4 includes in this preferred embodiment the ordinal numbers 1-26 associated with the string of data symbols (23;09;99;58;41;12345678910111213141516) combining the related example center string key. Line 42 in table 4 includes the ID data string of symbols part, of this preferred embodiment example center string key. The practical meaning of each digit in line 42 of table 4 is described by its associated ordinal number descriptive abbreviation (e.g. the two digits of the day of birth; D1/D2=23 in this example ). A selected number of groups are used for the processing of the inquiry and reply strings, which can be some or all of the groups that construct the central string key. By the specific example of FIG. 4. all groups accept for the credit card group are utilized. In line 42 the center string key consists of a total number of 6 groups, in this example only the first 5 groups are therefore selected for participation in the encoding process of the specific example related to creating the ordered data inquiry string. The relevant data symbols participating in the process are all the digits derived from the first 5 groups in the line 42 center string key (from left to right). Each one of the 5 selected groups covering the user birth date and secret number data, is constructed of two digits in this example. Line 44 in table 4 includes the textual description for each group, or of a logically associated number of groups (e.g. birth date). Line 46 in table 4 displays the ordered (in this example the permuted) ordinal numbers, thus creating the data inquiry string of this preferred example. The permuted string of ordinal numbers (1;10;8;4;5;6;7;3;9;2 in this example) is serving, in a preferred embodiment of the present invention, as the identification center transmitted encoding directions for the user to execute the ordering steps on the center string key associated string of symbols, in order to create the ID data user reply string, each symbol having an associate ordinal number as they appear in the center string key structure. In another preferred embodiment of the present invention the data inquiry string can be generated by the user himself and not by the identification center. In both of these preferred embodiments these inquiry string embedded encoding directions are sent to the user for executing the required reply encoding process. The user, as in this example, is responding to the data inquiry string, represented in the 5 groups data inquiry string (1,10),(8,4),(5,6),(7,3),(9,2) as detailed in line 46. The user response is in the form of an ordered user ID data reply string, where the user is using for the required reply string generation, the center string key data symbols which are always stored for reference at the user's terminal.

In another preferred embodiment of the present invention the data inquiry string can be generated by the intermediate service provider and then sent in parallel to both the user and the identification center. In this case the user receives the inquiry string from the intermediate service provider, the user then generates only the ordered ID data reply string and sends it directly to the Identification center, or indirectly through the intermediate service provider. Following the receipt of the ID data reply string the identification center executes and finalizes in the following steps the identification process, according to the present invention steps, as detailed herein.

Line 50 in table 4 is the final result of the user encoding procedure; The present example final ID data reply string data string of symbols as it appears in line 50, is composed of the digits 1;9;9;0;3 and is representing for the present example an ordered ID data reply string which execution is done by two steps, the first of which is done by adding the missing digits information into the blank spaces of line 32 of table 3. Line 47 and the following step described by line 50, are a description of the two steps procedure for the creation of an ordered user ID data reply string in this preferred example, later to be transmitted back by the user to the identification center. The ordered user ID data reply string preparation, as done by the user, is based in this example on the following two consecutive encoding steps; (I) the ordering step exercised by interchanging positions (permutations) of the center string key symbols (in this example; digits), within a selected number of groups, the end results are represented by line 47 (in this example 21;89;99;50;23) after this step the execution upon them of a further step: (ii) implementing a function ; in this example, a one-out-of-two logical function. In the first group of this example the digit (1) was selected out of the group of two digits (2;1) composing this previous step associated group. The results of the second step are displayed in line 50 (in this example 1;9;9;0;3;). In other preferred embodiments of the present invention the function exercised in the second step can be different then the one implemented in this example and may be addition of the selected symbols in the group, multiplication of the symbols, a modulo (n) addition, selection of n out of m symbols, or any other selected mathematical or logical function. Each group consists of two data digits in line 47, is associated with its ordinal number descriptive ID meaning abbreviation (e.g. ordinal numbers 1;10 from the first inquiry group are associated with D1/R2) in line 48. The credit card number consisting of a group of 16 digits in this preferred embodiment, is not a part of the selected inquiry groups and therefore its data symbols are not involved in the ordering (permuting) procedure of the data symbols for the ordered user ID data reply string described above. Line 50, which in this preferred embodiment is the ordered user ID data reply string, includes an encoded string of digits having a substantial encryption complication level. It will be hard for an unauthorized entity to determine out of the related reply string, the original symbols structuring the secret, namely the center string key, shared between the user and the identification center, which is the center key string. It would be difficult to an unauthorized entity to learn the secret from the information revealed in the reply string, moreover, considering that in any consequent communication and identification process between the user and the identification center, a different inquiry string will be used it will be difficult to learn any information by tapping to subsequent communication between the user and the communication center. Obviously, in order to further hinder on the unauthorized party, the shared secret itself may be changed from time to time, the whole communication between the user and the identification center may be encrypted, etc.

Those close to the art will readily appreciate that the actual nature of communication between the user and the identification center is not bound by the specific table representation and the contents thereof, as demonstrated in FIGS. 2, 3 and 4.

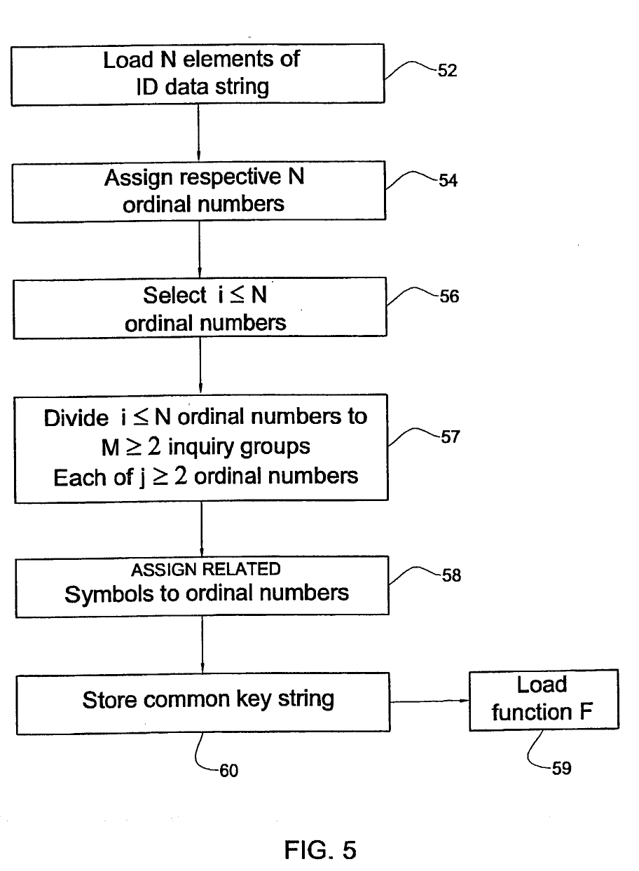

FIG. 5 illustrates in a logical flow diagram form, a flow chart 5 containing the logical blocks of the algorithm implemented to create the center string key that is stored in both the identification center and the user terminal memories, in accordance with one embodiment of the present invention. Block 52 describes the first step of loading the string of the ID data symbols, as supplied by the user. Block 54 describes the step of assigning an ordinal number to each symbol of the string of ID data symbols, supplied by the user. Block 56 describes the step of creating one of a variety of possible center string keys from the same string of N user ID data symbols, by first selecting a partial group of I ordinal numbers out of the previously assigned string of N≧I ordinal numbers. Block 57 describes the following step of creating the specific selected center string key final structure by first dividing the previous step selected partial group of I≦N ordinal numbers, to M≧2 groups, each of j≧2 ordinal numbers. Block 58 describes the step of reassigning the associated symbols of block 52 loaded N symbols of ID data, to the grouped ordinal numbers of block 57 step. Block 59 describes the step of loading the selected function, or in one preferred embodiment a set of (I) functions, that will be implemented upon the k≦j(I) symbols that corresponds to k ordinal numbers in the related center string key group (I). The results of the selected function implementation are placed in the respective user reply group, as previously explained in the description of FIG. 4. Block 60 describes the step of storing the results of block 58 operations and function block 59 in the memories of both the identification center and the user's terminals.

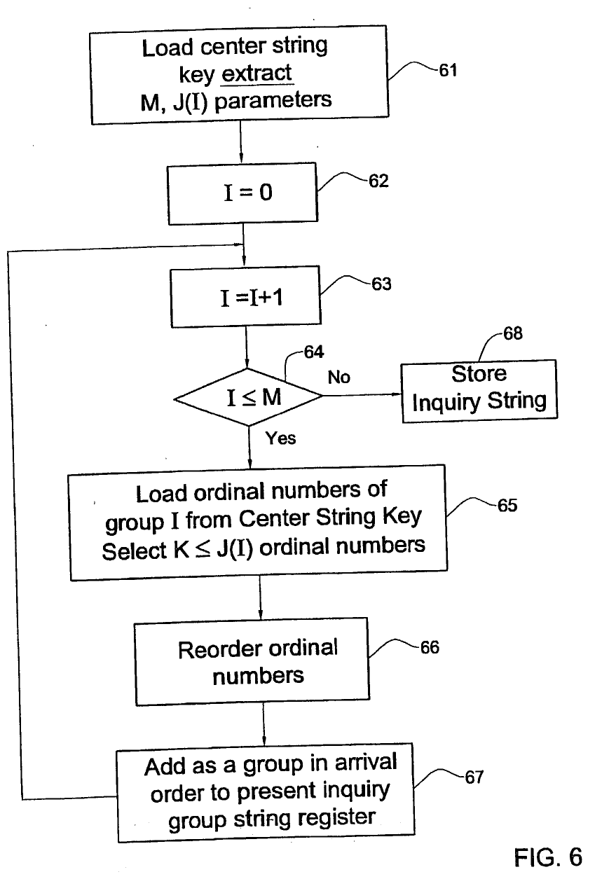

FIG. 6 illustrates in a logical flow diagram form, a flow chart 6 containing the logical blocks of the algorithm implemented to create the ordered user ID data inquiry string. The flow chart 6 blocks demonstrates the inquiry string construction steps process, executed by the identification center in one preferred embodiment and by the user in another preferred embodiment of the present invention. Block 61 describes the first step of the user in one embodiment, or the identification in another embodiment, by which loading from the memory the stored data table containing the center string key and extracting out of it the parameters; M the numbers of groups in the string, j(I) the number of symbols in each group (I) and the function, or a set of functions F, to be implemented on the selected groups of symbols. Block 62 describes the step of an initial zero value to the counting parameter I. Block 63 describes the step of assigning a new value of I=1+1 to previous I value for present iteration cycle I. Block 64 describes the step of the identification center, or the user in another preferred embodiment, testing and deciding if the present I value is equal or smaller than M. If YES the identification center, or the user in another preferred embodiment, continues to execute the iteration loop operations described in blocks 65,66 and 67, as detailed in the following paragraph description, if NO the identification center, or the user in another preferred embodiment, activates a reading act of the present state of the inquiry group accumulation results register 67. Block 65 of the iteration loop describes the step of the identification center, or the user in another preferred embodiment loading an i serial number group from the groups of ordinal numbers and selecting out of it K≦j(I) symbols. Block 66 describes the two steps implemented by the user on the i group selected k symbols, combined of; (a) the identification center, or the user in another preferred embodiment, implementing a reordering procedure upon ordinal numbers from different groups in the string according to the reordering procedure the identification center, or the user in another preferred embodiment, has decided to permute in the received center string key, as exemplified in the permutation done between spaces 33 and 34 in FIG. 3. and; (b) function F operator execution on every selected K≦j(i) number of symbols for every i≦M group. Block 67 describes the step of the identification center, or the user in another preferred embodiment, implementing a linear software register to create a string of ordinal numbers, by accumulating blocks 65,66 and 67 steps execution results, on each selected group i. The linear register data accumulation steps are required to construct an ordered inquiry string. Block 68 describes the step of implementing a register reading and storage of an ordered inquiry string being the contents of block 67 register when I=M.

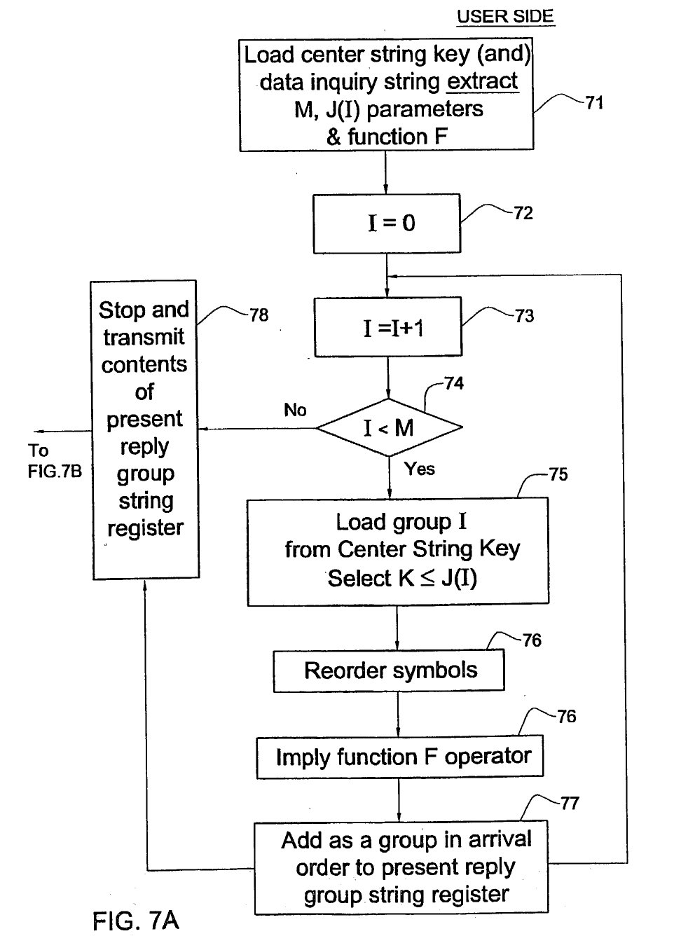

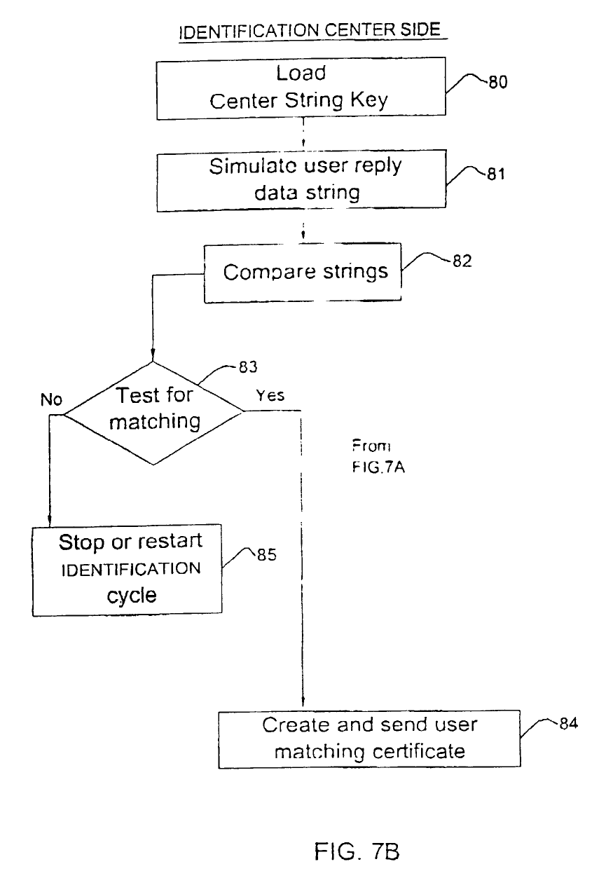

FIG. 7 illustrates in a logical flow diagram form the operational steps of system 1 described in FIG. 1, where the system is composed of a user terminal, and an identification center and the intermediate service provider is not present. FIG. 7 illustrates, a flow chart 7 containing the logical blocks and the related logic steps, of the algorithm implemented to create the identification by executing a simple procedure to compare symbols from the reply group to the associated symbols from a simulated reply group and by that creating a matching verification at the identification center, according to the present invention. The right side blocks demonstrate the identification process steps executed by the user and the left side of the flow chart demonstrates those logical steps done by the identification center. Block 71 describes the first step of the user by loading the stored data table containing the center string key and extracting out of it the parameters; M the numbers of groups in the string, j(I) the number of symbols in each group I and the function, or a set of functions F, to be implemented on the selected groups of symbols. Block 72 describes the step of an initial zero value to the counting parameter I. Block 73 describes the step of assigning a new value of I=1+1 to previous I value for present iteration cycle I. Block 74 describes the step of the user testing and deciding if the present I value is equal or smaller than M. If YES the user continues execute the iteration loop operations described in blocks 75,76 and 77, as detailed in the following paragraph description, if NO the user activates a reading act of the present state of the reply group accumulation results register 77. Block 75 of the iteration loop describes the step of the user loading an I serial number group from the groups of ID data symbols and selecting out of it K≦j(I) symbols. Block 76 describes the two steps implemented by the user on the I group selected k symbols, combined of; (a) the user implementing a reordering procedure upon symbols from different groups in the string according to the reordering status of the ordinal numbers in the received inquiry string, and (b) function F operator execution on every selected K≦j(I) number of symbols for every I≦M group, to clarify; in FIG. 4. the first step (a) is the permutation of digit 3 (D2) in the first group of line 42 with the digit 1 (R2) in the fifth group in line 42 the results is the group of digits 21 in the first space of line 47. The second step (b) is the implementation of the logical function of one out of two on the first group displayed in space one of line 47 in FIG. 4. the result of which, the digit 1 is displayed in the first space of line 50. Block 77 describes the step of the user implementing a linear software register to create a string of symbols by accumulating blocks 75,76 and 77 steps execution results, on each selected group I. The linear register data accumulation steps are required to construct an ordered user ID data reply string. Block 78 describes the step of the user implementing a register reading and an ordered user ID data reply string transfer procedure of the contents of block 77 register if I=M. Turning now to the Identification center side, block 80 describes the step of the identification center implementing a reading and loading procedure of the contents of its memory containing the data table of the center string key. Block 81 describes the step of the identification center simulating the logic and mathematical steps described in blocks 71,72,73,74,75,76,77,78. to create a simulated reply string. Block 82 describes the step of the identification center executing a comparison operation on the received ordered user ID data reply string 78 and the internally simulated ID data reply string 81. Block 83 describes the step of the identification center executing a conditional decision step; if the score indicating a matching degree derived by the comparison results of block 82 is sufficient, then a matching certificate 84 is generated, otherwise as indicated in block 85, a stop identification process, or alternatively a restart command for a new user identification procedure, is generated.

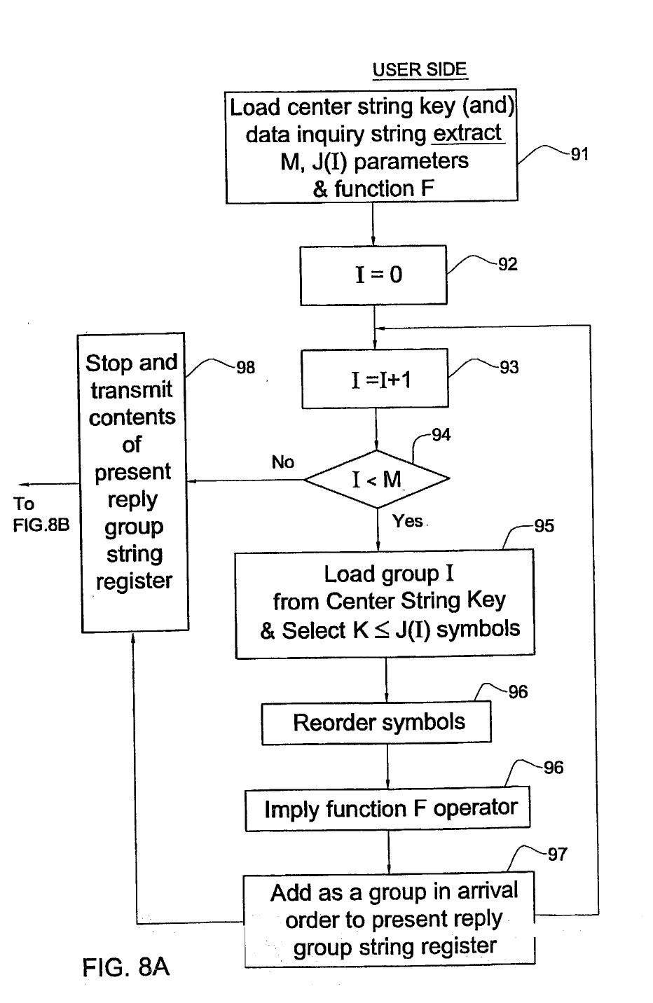

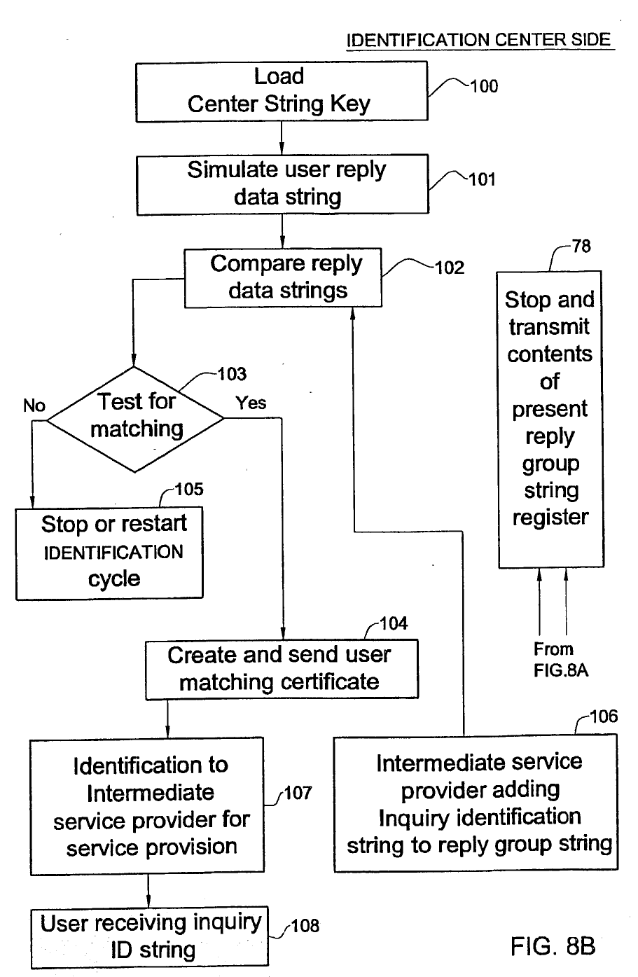

FIG. 8 illustrates a specific embodiment of the present invention where the system includes also an intermediate service provider through which the user is communicating with the identification center. The roll of the intermediate service provider in this embodiment is to execute a transaction with the user, subject to the intermediate service provider receiving an identification certificate from the identification center. FIG. 8 illustrates in a logical flow diagram form the operational steps of system 1 described in FIG. 1, where the system is composed of a user terminal, an intermediate service provider and an identification center. Flow chart 8 is containing the logical blocks and the related logic steps, of the algorithm implemented to create the positive identification matching certificate at the identification center, and an inquiry identification string at the intermediate service provider terminal, according to this preferred embodiment of the present invention. The right side blocks demonstrate the identification process steps executed by the user and the left side of the flow chart demonstrates those logical steps done by the identification center. The left lower side of the drawing describes the blocks of the intermediate service provider part of the related process steps. Block 91 describes the first step of the user by loading the stored data table containing the center string key and extracting out of it the parameters; M the numbers of groups in the string, j(I) the number of symbols in each group I and the function or set functions F, to be implemented on the selected groups of symbols. Block 92-97 describes the same steps described under steps 71-77 in FIG. 6. In FIG. 7 block 78 transferred the results to the block of comparing strings 82 in the identification center, while in this embodiment of the present invention block 98 transfers the results to block 106 at the intermediate service provider terminal side. Block 106 describes the step of the intermediate service provider receives the ordered user ID data reply string from block 98 and add to it an inquiry identification string before sending the two strings for further relevant strings data comparison, under block 102 function step. Block 100 describes the step of the identification center implementing a reading and loading procedure of the contents of its memory containing the data table of the center string key. Block 101 describes the step of the identification center simulating the logic and mathematical steps described in blocks 91,92,93,94,95,96,97,98. to create a simulated reply string. Block 102 describes the step of the identification center executing a comparison operation on the received ordered user ID data reply string 98 and the internally simulated ID data reply string 101. Block 103 describes the step of the identification center executing a conditional decision step; if the comparison results of block 92 are positive, then a matching certificate 104 is generated, otherwise a stop identification process, or a restart command for a new user identification procedure 105 is generated. If a user matching certificate is created then an indication 107 to provide a service or to generate a product sale is transferred from the identification center to the intermediate service provider. If such an indication 107 is sent to the service provider then the service provider sends to the user an approval 108, in the form of an inquiry ID string.

In another embodiment of the present invention described also by FIG. 8, the user is preparing and sending two separate and different ordered user ID reply strings, one string prepared under block 98 is sent to the identification center, starting in block 102 for the executing the process of authentication and approval, as described in the above described sequence of operations of blocks 103, 104, 105, 107 and 108. The other ordered user ID reply string is sent by the user to the intermediate service provider from block 98 to block 106 and from this stage the user ID reply string is transferred again to the identification center block 102, for a parallel process of authentication for both of the two ordered user ID reply strings. In this embodiment, only if the authentication process is successfully accomplished through both parallel authentication processes, then the identification center approves the deal by sending an adequate message to both the user and the Intermediate service provider and a deal is further processed and finalized between the user and the intermediate service provider under the approval of the identification center. This embodiment wherein the user is sending two different user ordered ID reply strings is aimed to provide higher security to the transaction execution. In such a case the user can avoid the situation wherein the intermediate service provider can send a false reply string to the identification center and get an approval for the transaction without getting the user's approval. In this embodiment the transaction will be approved only in the case the identification center authenticates to the user and the intermediate service provider in parallel the reply string transferred and received through the intermediate service provider and as in the same time it approves and authenticates through direct communication with the user the authenticity of the second user ordered ID reply string.

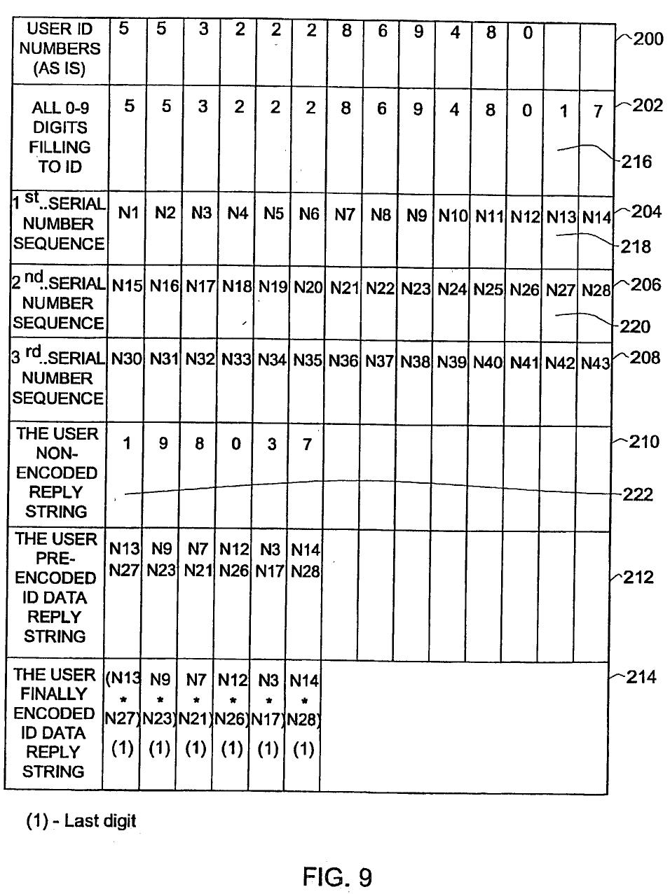

FIG. 9 is a table 9 that illustrates some embodiments of the present invention. Table 9 contains an example of a user ID number and the use of this number by the user to further encode the string of symbols—namely the ordered user ID data reply string. The encoded ordered user ID data reply string is prepared by the user through his terminal using a simple software module, preferably supplied by the identification center. At the end of the encoding process the encoded ordered user ID data reply string is sent by the user back to the identification center for the user ID authentication.

Line 200 is the line containing the user selected ID number of 12 digits of the digits (5,5,3,2,2,2,8,6,9,4,8,0). The user is feeding this number to the computer terminal where either manually or automatically additional digits are added to the line 200 digits group, in order to create a string containing all possible 10 digits, from 0 to 9, as displayed in line 202 wherein the digits 1 and 7 in a increasing order, are added to the original user selected ID number of line 200 to create a new serial group of digits containing 14 digits. (5, 5, 3, 2, 2, 2, 8, 6, 9, 4, 8, 0, 1, 7). In this example the missing digits were added in the suffix of the ID digits line but they can be added in the general case in any place in the string and also in a descending digits order, or any combination thereof, as can be mutually agreed between the user and the identification center in any point of time, prior to the start of the identification and authentication procedure.

Line 204 illustrates the present invention embodiment example wherein the encoding process starts by assigning and fitting a set of 14 running serial numbers N1 . . . N14, each of the running numbers in line 204 is assigned and correspond to each said digit in the new serial group of digits as appears in line 202. This process is repeated with additional steps of assigning additional sets of running serial numbers to the new serial group of digits of line 202, each time with a new set of consecutive running serial numbers, for at least N times, in this example it shown only for 3 lines; 204, 206, 208 for this specific example, practically it may be continued for up to any number of M lines.

Line 210 is an example of the ordered user ID reply string containing the symbols 1,9,8,0,3,7 ( only digits in this example) according to the present invention. The ordered user ID reply string of line 210 was prepared at the user terminal prior to the execution of the herewith described encoding process.

In line 212 the encoding process is further developed by changing each of the digits of the original group of digits of line 210 by a group of two numbers each of this numbers is selected from a separate line of running serial numbers as demonstrated in lines 204 and 206. In this example the first digit “1”, marked as 222 in the original user ID reply string of line 210, is replaced by the numbers N13 (marked as 218) and N27 (marked as 220) that appear under the digit 1 ( marked 216) of line 202. In the same way the following digit “9” in line 210 is replaced by the two numbers N9 and N23 that appear under the digit 9 in line 202, and so on until all digits in line 210 are replaced by pair of numbers from lines 204 and 206.

In line 214 an additional encoding step is introduced, wherein the pair of numbers in line 212 are multiplied by each other and only the least significant digit in each of the multiplication resulting number is inserted to the encoded final string of line 214. In another example the most significant digits of the multiplication results can be selected. The function operated on the two selected numbers from the set of running serial numbers Nij, can be any other mathematical or logic function, for example division of one number by the other, sum of the two numbers, or subtraction of one number from the other. In other cases the function can be the first number Nij raised in the power of the second Nij number. To further complicate the encoding process the result of each of the functions implementation upon the pair of numbers Nij can be further calculated on the base of “Modulo A” arithmetic, were A can be any one of the two Nij selected numbers, or any other number previously agreed upon by the user and the identification center.

The above encoding process is repeated in the identification center. After the generation of the simulated ordered user ID reply string the encoding process described above is done at the identification center on the simulated ordered user ID reply string and the results are matched to the encoded ordered user ID reply string received from the user terminal through the communication network for the generating of an authentication certificate, only in the case both strings are matching.

While the invention has been described with respect to a limited number of embodiments, it will be appreciated that many variations, modifications and other applications of the invention may be made.

In the method claims that follow, alphabetic characters used to designate claim steps are provided for convenience only and do not imply any particular order of performing the steps.

1. A method for establishing secured identification and authentication procedure over a communication network, of a user by an identification center, comprising the steps of;
(a) providing to the user and the identification center a data inquiry string including instructions for guided transformations on a part or a whole of a center string key, wherein said center string key includes N symbols and is common to both the identification center and the user;
(b) the user constructing a user ID data reply string, by executing said guided transformations on said part or said whole of said center string key, said guided transformations causing said user ID data reply string to have a substantial encryption complication level so that it would be hard to determine said center string key from said user ID data reply string;
(c) the user sending said user ID data reply string;
(d) the identification center receiving said user ID data reply string,
(e) for a subset of center string keys accessible to the identification center, the identification center executing said guided transformations on a part or a whole of each center string key thereby creating a series of simulated user ID data reply strings, each in respect of a different center string key, each simulated user ID data reply string being associated with a score indicating the matching degree between said received user ID data reply string and the respective simulated user ID data reply string;
(f) the identification center selecting the simulated user ID data reply string having the highest score to identify a corresponding center string key and therefrom the most likely user;
(g) the identification center providing an indication whether the highest score is sufficient or not;
(h) the user receiving an indication whether the highest score is sufficient or not.

2. The method of claim 1, wherein said step (a) includes the step of: the identification center constructing said data inquiry string and sending said data inquiry string to the user.

3. The method of claim 1, wherein said step (a) includes the step of:
the user constructing said data inquiry string and sending said data inquiry string to the identification center.

4. The method of claim 1, wherein said step (a) includes the step of: an intermediate service provider constructing said data inquiry string and sending said data inquiry string to both the user and the identification center.

5. The method of any of the preceding claims, wherein said step (c) includes the step of: the user sending to an intermediate service provider said user ID data reply string and said intermediate service provider sending said user ID data reply string to the identification center, and wherein said step (d) includes the step of the identification center receiving said user ID data reply string from said intermediate service provider,
and wherein said step (g) includes the step of: the identification center providing to said intermediate service provider an indication whether the highest score is sufficient or not, which if sufficient allows said intermediate service provider to execute a transaction on behalf of the user, and wherein said step (h) includes the step of: the user receiving from said intermediate service provider an indication of execution or not of said transaction, thereby receiving an indication of whether the highest score is sufficient or not.

6. The method of any of the preceding claims, wherein step (c) includes the step of: the user sending at least two different user ID data reply strings, at least one of said at least two to the identification center and at least one other of said at least two to an intermediate service provider, and wherein step (d) includes the step of the identification center receiving said at least two user ID data reply strings, said at least one of said at least two from the user and said at least one other of said at least two from said intermediate service provider, and wherein said steps (e) and (f) are performed for each of said at least two user ID data reply strings, and wherein step (g) includes the step of: the identification center providing an indication to said intermediate service provider and an indication to the user of whether all highest scores, each associated with one of said at least two user ID data reply strings, are sufficient or not to authenticate a same user, which if sufficient allows said intermediate service provider to execute a transaction on behalf of the user, and wherein said step (h) includes the step of: the user receiving said indication of whether all highest scores are sufficient or not from the identification center.

7. The method of claim 5 or 6, wherein said step (d) further includes the step of: the identification center receiving an inquiry identification string along with any user ID data reply string received from said intermediate service provider; and wherein in step (g) said sufficient indication provided to said intermediate service provider includes said inquiry identification string and wherein in step (h) said sufficient indication received by the user includes said inquiry identification string.

8. The method of any of the preceding claims, further comprising the step of:
(i) If insufficient indication is provided as stipulated in step (g), repeating said steps (a) to (h) a number M≧1 cycles and in each one of said M times, activating an action selected from the group that includes: (1) stopping said identification process and declaring failure and (2) providing a new data inquiry string that includes a different set of instructions for guided transformations as stipulated in said step (a); and executing said steps (a) to (b)

9. The method of any of the preceding claims, wherein said matching degree is based on a rule that a predefined percent P of user ID data reply string symbols being identical to corresponding symbols in said simulated reply.

10. The method of claim 9, wherein said predefined P equals 100 percent.

11. The method of any of the preceding claims, wherein said symbols are all digits.

12. The method of any of the preceding claims, wherein said center string key of symbols is structured of at least one element selected from a group including the user's credit card number, the user's credit card secret number, the user's birth date, the user's passport number, the user's driving license and the user's personal identity number.

13. The method of any of the preceding claims, wherein said N symbols are associated with respective N ordinal numbers and said step (a) includes the steps of: (i) dividing said center string key into at least two groups, each including a respective j≧2 ordinal numbers; (ii) reordering said ordinal numbers in said center string key and constructing a data inquiry string that includes at least two inquiry groups, and (iii) providing to the user and the identification center said data inquiry string; and wherein step (b) includes the steps of: (i) the user constructing a user ID data reply string that includes at least two reply groups that correspond to said at least two inquiry groups by performing: for each group, selecting k≦j symbols that correspond to k ordinal numbers in said inquiry group and placing them or a function thereof in the respective user reply group, the user reply group does not include indication as to correspondence between the k symbols and the k ordinal numbers.

14. The method of claim 13, wherein said function creates a number as the results of its operation on said k≦j symbols, in each one of said reply groups.

15. The method of claim 13, wherein said function is a selection of k symbols out of j symbols in each of one of said reply groups.

16. The method of claim 13, wherein said function is selected from the group including at least the functions of: one out of two logical function, addition of selected symbols, multiplication of selected symbols, a modulo (n) addition, and selection of n out of m symbols.

17. A computer program comprising computer program code means for performing all the steps of any of the preceding claims when said program is run on a computer.

18. A system for establishing a secured identification and authentication procedure of a user through a user terminal by an identification center through an identification center terminal, the user terminal connected via a communication network with the identification center terminal, the identification center terminal is configured to perform the steps of:
(a) receiving a user ID data reply string from the user terminal or from an intermediate service provider terminal which is also connected via the communication network, said user ID data reply string having been constructed by the user terminal executing guided transformations on a part or a whole of a center string key, said guided transformations causing said user ID data reply string to have a substantial encryption complication level so that it would be hard to determine said center string key from said user ID data reply string, wherein instructions for said guided transformations were included in a data inquiry string provided to the user terminal and the identification center terminal and wherein said center string key includes N symbols and is common to the identification center terminal and the user terminal;
(b) for a subset of center string keys accessible to the identification center terminal, executing said guided transformations on a part or a whole of each center string key thereby creating a series of simulated user ID data reply strings, each, in respect of a different center string key, each simulated user ID data reply string being associated with a score indicating the matching degree between said received user ID data reply string and the respective simulated user ID data reply string;
(c) selecting the simulated user ID data reply string having the highest score to identify a corresponding center string key and therefrom the most likely user;
(d) providing an indication to the user terminal or to said intermediate service provider terminal whether the highest score is sufficient or not.

19. A system for establishing a secured identification and authentication procedure of a user through a user terminal by an identification center through an identification center terminal, the user terminal connected via a communication network with the identification center terminal, the user terminal is configured to perform the steps of:
(a) constructing a user ID data reply string, by executing guided transformations on a part or a whole of a center string key, said guided transformations causing said user ID data reply string to have a substantial encryption complication level so that it would be hard to determine said center string key from said user ID data reply string, wherein instructions for said guided transformations were included in a data inquiry string provided to the user terminal and the identification center terminal and wherein said center string key includes N symbols and is common to the identification center terminal and the user terminal;
(b) sending said user ID data reply string to an intermediate service provider terminal which is also connected via the communication network for transfer to the identification center terminal, or to the identification center terminal;
(c) receiving an indication whether a highest score is sufficient or not from the identification terminal or from said intermediate service provider terminal, wherein said sent user ID data reply string allows the identification center terminal to associate a score indicating the matching degree between each of a series of simulated user ID data reply strings and said sent user ID data reply string, to select the simulated user ID data reply string associated with the highest score, and to indicate to the user terminal or to said intermediate service provider terminal whether the highest score is sufficient or not.
